(19) United States
(12) Patent Application Publication
(10) Pub. No.: US 2017/0272430 A1
(43) Pub. Date: Sep. 21, 2017

(54) AUTHENTICATION METHOD, APPARATUS AND SYSTEM FOR DEVICE

(71) Applicant: BOE TECHNOLOGY GROUP CO., LTD., Beijing (CN)

(72) Inventor: XIN LI, Beijing (CN)

(21) Appl. No.: 15/329,071

(22) PCT Filed: Sep. 7, 2016
(86) PCT No.: PCT/CN2016/098345

§ 371 Date: Jan. 25, 2017

(30) Foreign Application Priority Data
Oct. 15, 2015 (CN) 201510667047.8

(51) Int. Cl. H04L 29/06; G06F 21/36

(52) U.S. Cl. CPC H04L 63/0861; H04L 63/083; G06F 21/36; G06K 9/00288

(57) ABSTRACT

An authentication method, apparatus and system for a device are disclosed. The authentication method includes: selecting at least one of second devices associated with a first device and having an authentication function, if an authentication function of the first device is determined to be faulty; and instructing the selected second device to perform a locking/unlocking authentication operation on the first device. The above method helps to solve the problem of not capable of performing a locking/unlocking authentication operation when the authentication function of the device is faulty, which improves the flexibility and practicability of device authentication.

### FIELD OF THE ART

Embodiments of the disclosure relate to the technical field of device authentication, more particularly, to an authentication method, an authentication apparatus and an authentication system for a device.

### BACKGROUND

For conventional devices such as display devices, a device normally has various different locking and unlocking authentication functions to provide better user experience. For example, a fingerprint authentication function, a password authentication function or a voice authentication function and the like may be provided in the same device. In this way, such a device may use its corresponding authentication methods to realize corresponding locking and unlocking authentication operations based on the authentication functions provided therewith.

However, the device can only rely on itself to perform the corresponding locking and unlocking authentication operation. That is, a device A having locking and unlocking authentication functions can only uses the locking and unlocking functions of itself to perform locking and unlocking authentication operations on the device A. As a result, when the locking and unlocking authentication functions of the device A are faulty, it will become impossible to perform locking and unlocking authentication operation on the device A. The flexibility and practicability of the locking and unlocking authentication of the device is therefore decreased, which makes its user to have bad experience.

### SUMMARY

Embodiments of the disclosure provide an authentication method, an authentication apparatus and an authentication system for a device, which aim to solve the problem of not capable of performing a locking/unlocking authentication operation when the authentication function of the device is faulty.

In a first aspect of the disclosure, it is provided an authentication method for a device, the method comprises: selecting at least one of second devices associated with a first device and having an authentication function, in condition that an authentication function of the first device is determined to be faulty; and instructing the selected second device to perform a locking/unlocking authentication operation on the first device.

In a second aspect of the disclosure, it is provided an authentication apparatus for a device, the apparatus comprises: a determination module for determining whether an authentication function of the first device is faulty; and a processing module for selecting at least one of second devices associated with the first device and having an authentication function, in condition that an authentication function of the first device is determined to be faulty, and for instructing the selected second device to perform a locking/unlocking authentication operation on the first device.

In a third aspect of the disclosure, it is provided an authentication system for a device, the system comprises a first device, at least one second device associated with the first device and having an authentication function, and an authentication apparatus for a device, wherein the authentication apparatus is configured for selecting one device from the at least one second devices associated with the first device and having an authentication function, in condition that an authentication function of the first device is determined to be faulty, and for instructing the selected second device to perform a locking/unlocking authentication operation on the first device; and the second device is configured for performing the locking/unlocking authentication operation on the first device according to the instruction from the authentication apparatus.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some of embodiments of the disclosure and thus are not limitative of the disclosure.

FIG. 1 schematically illustrates a flow chart of an authentication method for a device in accordance with an embodiment of the disclosure;

FIG. 2 schematically illustrates a diagram of an authentication apparatus for a device in accordance with another embodiment of the disclosure; and

FIG. 3 schematically illustrates a diagram of an authentication system for a device in accordance with still another embodiment of the disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

### Embodiment 1

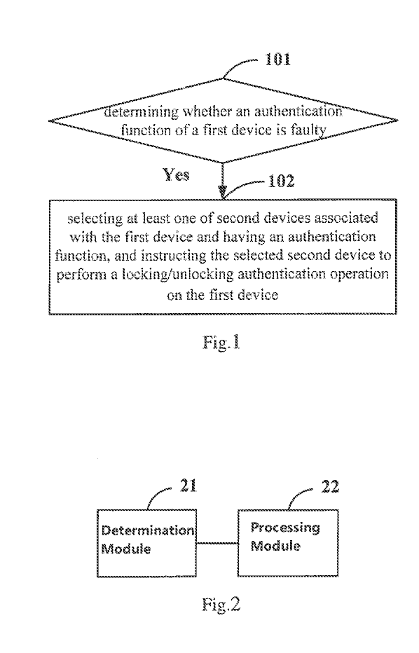

Embodiment 1 of the disclosure provides an authentication method for a device. FIG. 1 schematically illustrates a flow chart of the authentication method in accordance with the embodiment of the disclosure. The method may comprise the following steps:

Step 101: determining whether an authentication function of a first device is faulty; if the authentication function of the first device is faulty, proceed to step 102.

As an example, the authentication function may comprise one or more of a biometric authentication function, a gesture authentication function, a voice authentication function and a password authentication function. Herein, the biometric authentication function may comprise at least one of a fingerprint authentication function and a face recognition authentication function, which will not be elaborated here.

That is to say, any device may have one or more authentication functions. Accordingly, the step 101 may refer to that: determining all authentication functions of the first device are faulty. It can be contemplated that when only part of the authentication functions of the first device are faulty, step 102 may be further performed, which will not be elaborated here.

Step 102: selecting at least one of second devices associated with the first device and having an authentication function, and instructing the selected second device to perform a locking/unlocking authentication operation on the first device.

As an example, for practical implementation of device authentication, the step of selecting at least one of second devices associated with the first device and having an authentication function may be implemented as follows:

Selecting, from the at least one of second devices associated with the first device and having an authentication function, one device whose authentication function comprises any one or more of authentication functions which the first device have, such that the second device may perform locking/unlocking operation on the first device according to the authentication functions of the first device that the second device has.

Of course, in addition to the above selection method, it may also select any one of the second devices associated with the first device and having an authentication function as the finally selected second device, which is not limitative to the embodiment of invention. If the authentication functions of the selected second device do not include the authentication functions of the first device, locking/unlocking information corresponding to different authentication functions may be converted from one to another, which will not be elaborated here.

That is to say, several devices having authentication functions may be associated with each other first. By this means, when one of the devices fails to be locked or unlocked due to its authentication functions are faulty, locking/unlocking operations may be performed on other associated devices having the corresponding authentication functions, so that the device may be locked or unlocked.

As an example, when one of the device cannot switch on due to a faulty password authentication function, a fingerprint unlocking operation may be performed on other associated devices having the corresponding fingerprint authentication functions, such that the device may be switched on.

In at least one of the embodiment, the method may further comprise: if it is determined that a distance between the first device and the corresponding second device is greater than or equal to a predetermined threshold value (the predetermined threshold value may be adjusted as needed), then a device is selected from the at least one of the second devices having authentication function and associated with the first device, and the selected second device is instructed to encrypt the first device for a second time (e.g., enabling other encryption program in the first device).

That is to say, when it is determined that the first device is far away from its corresponding terminal user and therefore making a security level of the first device relatively low (for example, it is very likely the first device is lost), the second device associated therewith and having the corresponding authentication functions may be used to encrypt the first device for a second time, such that the security level of the first device is increased.

As an example, instructing the selected second device to encrypt the first device for a second time may comprise:

instructing the selected second device to use another authentication method different from an original authentication method used by the first device to encrypt the first device for a second time, so as to further increase the security level of the first device.

It can be contemplated that it may also instruct the selected second device to use an authentication method which is the same as the original authentication method used by the first device to encrypt the first device for a second time, which will not be elaborated here.

As an example, the other authentication methods may comprise No Shutdown, or, it may also include one or more of a biometric authentication method, a gesture authentication method, a voice authentication method and a password authentication method, which will not be elaborated here.

In at least some of embodiments of the disclosure, the method may further comprise the following step:

if it is determined that a distance between the first device and the corresponding second device is greater than or equal to a predetermined threshold value, then the first device is instructed to report position information of the first device to a configured control center.

That is to say, when it is determined that the first device is far away from its corresponding terminal user and therefore making a security level of the first device relatively low (for example, it is very likely the first device is lost), the first device may be instructed to report the position information of the first device to the configured control center (such as a control center of the police), such that an accurate position information of the first device may be obtained in time.

As an example, at the same time of or after the second device encrypts the first device for a second time, for example, at the same time of or after the second device enables other encryption program of the first device, the first device may automatically report its position information to the configured control center, which will not be elaborated here.

Furthermore, the first and second devices of the disclosure may be any one of a device having an authentication function, such as a mobile phone, a tablet PC, a personal computer, which is not limitative to the embodiment of the disclosure.

The embodiment of the disclosure provides an authentication method for a device. If it is determined that authentication function of the first device is faulty, then one of second devices associated with the first device and having authentication functions may be selected and instructed to perform locking/unlocking operations on the first device. It thereby helps to solve the problem of not capable of performing a locking/unlocking authentication operation when the authentication function of the device is faulty, which improves the flexibility and practicability of device authentication as well as user experience.

### Embodiment 2

The embodiment of the disclosure provides an authentication apparatus for a device. For detailed implementations of the authentication apparatus please refer to the description of Embodiment 1, which will not be elaborated here. FIG. 2 schematically illustrates a diagram of the authentication apparatus in accordance with Embodiment 2 of the disclosure. The authentication apparatus may comprise:

a determination module 21, for determining whether an authentication function of the first device is faulty;

a processing module 22, for selecting at least one of second devices associated with the first device and having an authentication function, when it is determined according to determination result of the determination module 21 that an authentication function of the first device is faulty, and for instructing the selected second device to perform a locking/unlocking authentication operation on the first device.

As an example, the authentication function may comprise one or more of a biometric authentication function, a gesture authentication function, a voice authentication function and a password authentication function.

As an example, the biometric authentication function may comprise at least one of a fingerprint authentication function and a face recognition function.

In at least some of embodiments, the determination module 21 may be further configured for determining whether a distance between the first device and the second device corresponding to the first device is greater than or equal to a predetermined threshold value.

In at least some of embodiments, the processing module 22 may be further configured for selecting a device from at least one of the second devices having authentication function and associated with the first device, and instructing the selected second device to encrypt the first device for a second time, when it is determined according to determination result of the determination module 21 that that the distance between the first device and the second device corresponding to the first device is greater than or equal to a predetermined threshold value.

As an example, the processing module 22 may be configured for instructing the selected second device to use an authentication method different from an original authentication method used by the first device to encrypt the first device for a second time.

As an example, the other authentication method comprises No Shutdown.

In at least some of embodiments, the processing module 22 is further configured for instructing the first device to report position information of the first device to a configured control center, when it is determined according to a determination result of the determination module 21 that a distance between the first device and the second device corresponding to the first device is greater than or equal to a predetermined threshold value.

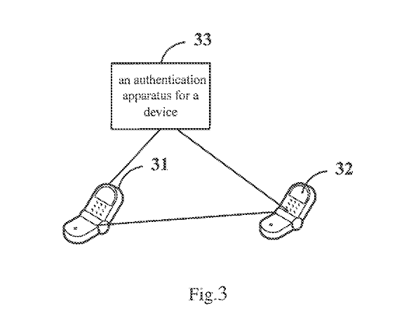

Embodiment 2 of the disclosure further provides an authentication system for a device. For detailed implementations of the authentication system please refer to the description of Embodiment, which will not be elaborated here. FIG. 3 schematically illustrates a diagram of the authentication system in accordance with Embodiment 2 of the disclosure. The authentication system may comprise a first device 31, at least a second device 32 associated with the first device 31 and having an authentication function, and an authentication apparatus 33 for a device, wherein:

the authentication apparatus 33 is configured for selecting at least one of second devices 32 associated with the first device 31 and having an authentication function, when it is determined that an authentication function of the first device 31 is faulty, and for instructing the selected second device 32 to perform a locking/unlocking authentication operation on the first device 31; and

the second device 32 is configured for performing the locking/unlocking authentication operation on the first device 31 according to the instruction from the authentication apparatus 33.

It is noted that the authentication apparatus 33 may be an apparatus independent from the first device 31 and the second device 32 or an integral apparatus arranged inside the first device 31 or the second device 32. In this case, the system may be regarded as having the first device and the second device 32, which will not be elaborated here.

The embodiment of the disclosure provides an authentication apparatus and system for a device. If it is determined that authentication functions of the first device are faulty, then one of second devices associated with the first device and having authentication functions may be selected and instructed to perform locking/unlocking operations on the first device. It thereby helps to solve the problem of not capable of performing a locking/unlocking authentication operation when the authentication function of the device is faulty, which improves the flexibility and practicability of device authentication as well as user experience.

A person skilled in the art will understand that the embodiments of the disclosure may be implemented as a method, apparatus (device) or a computer program product. Therefore, the disclosure may have hardware-only embodiments, software-only embodiments or software plus hardware embodiments. Moreover, the disclosure may be in the form of a computer program product embodied on one or more computer readable storage media (including but not limited to disc memory, CD-ROM, optical memory and the like) including computer readable program codes.

Those skilled in the art shall understand that the embodiments of the disclosure are able to be provided as a method, an apparatus (device) or a computer program product. Therefore, the disclosure can adopt forms of a complete hardware embodiment, a complete software embodiment or embodiment combining software and hardware. In addition, the disclosure can adopt the form of computer program product that is implemented on one or more computer applicable storage mediums (comprising, but not limited, disk memory, CD-ROM, optical memory, etc.) comprising computer applicable program codes therein.

The disclosure is described herein with reference to flowchart charts and/or block diagrams of methods, apparatuses (systems), and computer program products according to the embodiments of the disclosure. It should be understood that each flow and/or block in the flowchart and/or block diagram, and a combination of flow and/or block in the flowchart and/or block diagram can be implemented by computer program instructions. These computer program instructions may be provided to a general purpose computer, a special purpose computer, an embedded processor or a processor of other programmable data processing apparatus to form a machine, such that devices for implementing functions specified by one or more flows in the flowchart and/or one or more blocks in the block diagram may be generated by executing the instructions with the processor of the computer or other programmable data processing apparatus.

These computer program instructions may also be stored in a computer-readable memory that can direct the computer or other programmable data processing apparatus to operate in a given manner, so that the instructions stored in the computer-readable memory produce a manufactured article comprising an instruction device, and the instruction device implements the functions specified by one or more flows in the flowchart and/or one or more blocks in the block diagram.

These computer program instructions may also be loaded onto the computer or other programmable data processing apparatus, such that a series of process steps may be executed on the computer or other programmable data processing apparatus to produce process implemented by the computer, thereby, the instructions executed on the computer or other programmable data processing apparatus provide steps of implementing the functions specified by one or more flows in the flowchart and/or one or more blocks in the block diagram.

What is described above is related to the illustrative embodiments of the disclosure only and not limitative to the scope of the disclosure; the scopes of the disclosure are defined by the accompanying claims.

The present application claims priority from Chinese Application No. 201510667047.8, filed on Oct. 15, 2015, the disclosure of which is incorporated herein by reference in its entirety.

What is claimed is:

1. An authentication method for a device, comprising:
selecting at least one of second devices associated with a first device and having an authentication function, in condition that an authentication function of the first device is determined to be faulty; and
instructing the selected second device to perform a locking/unlocking authentication operation on the first device.

2. The method of claim 1, wherein the authentication function comprises one or more of a biometric authentication function, a gesture authentication function, a voice authentication function and a password authentication function.

3. The method of claim 2, wherein the biometric authentication function comprises at least one of a fingerprint authentication function and a face recognition function.

4. The method of claim 1, further comprising:
in condition that a distance between the first device and the at least one of the second devices associated with the first device and having an authentication function is greater than or equal to a predetermined threshold value, selecting a device from the at least one of the second devices, and instructing the selected second device to encrypt the first device for a second time.

5. The method of claim 4, wherein instructing the selected second device to encrypt the first device for a second time comprises:
instructing the selected second device to use a further authentication method different from an original authentication method used by the first device to encrypt the first device for a second time.

6. The method of any of claim 5, wherein the further authentication method comprises No Shutdown.

7. The method of claim 1, further comprising:
in condition that a distance between the first device and the at least one of the second devices associated with the first device is greater than or equal to a predetermined threshold value, instructing the first device to report position information of the first device to a configured control center.

8. An authentication apparatus for a device, comprising:
a determination module for determining whether an authentication function of the first device is faulty; and
a processing module for selecting at least one of second devices associated with the first device and having an authentication function, in condition that an authentication function of the first device is determined to be faulty, and for instructing the selected second device to perform a locking/unlocking authentication operation on the first device.

9. The apparatus of claim 8, wherein the authentication function comprises one or more of a biometric authentication function, a gesture authentication function, a voice authentication function and a password authentication function.

10. The apparatus of claim 9, wherein the biometric authentication function comprises at least one of a fingerprint authentication function and a face recognition function.

11. The apparatus of claim 8, wherein
the determination module is further configured for determining whether a distance between the first device and the at least one of the second devices associated with the first device is greater than or equal to a predetermined threshold value,
the processing module is further configured for selecting a device from at least one of the second devices associated with the first device and having an authentication function, and instructing the selected second device to encrypt the first device for a second time, in condition it is determined, according to a result of the determination module, that the distance between the first device and the at least one of the second devices associated with the first device is greater than or equal to a predetermined threshold value.

12. The apparatus of claim 11, wherein the processing module is further configured for instructing the selected second device to use a further authentication method different from an original authentication method used by the first device to encrypt the first device for a second time.

13. The apparatus of claim 12, wherein the further authentication methods comprise No Shutdown.

14. The apparatus of claim 11, wherein the processing module is further configured for instructing the first device to report position information of the first device to a configured control center, in condition it is determined, according to a result of the determination module, that a distance between the first device and the at least one of the second devices associated with the first device is greater than or equal to a predetermined threshold value.

15. An authentication system for a device, comprising a first device, at least one second device associated with the first device and having an authentication function, and an authentication apparatus for a device, wherein:
the authentication apparatus is configured for selecting one device from the at least one second devices associated with the first device and having an authentication function, in condition that an authentication function of the first device is determined to be faulty, and for instructing the selected second device to perform a locking/unlocking authentication operation on the first device; and
the second device is configured for performing the locking/unlocking authentication operation on the first device according to the instruction from the authentication apparatus.
